(19) United States
(12) Patent Application Publication
(10) Pub. No.: US 2007/0206792 A1
(43) Pub. Date: Sep. 6, 2007

(54) Library apparatus and library apparatus control method

(75) Inventor: Kinya Saito, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/710,491

(22) Filed: Feb. 26, 2007

(30) Foreign Application Priority Data
Feb. 27, 2006 (JP) 2006-051010
Nov. 13, 2006 (JP) 2006-306806

(51) Int. Cl. H04N 7/167

(52) U.S. Cl. 380/201

(57) ABSTRACT

The present invention provides a library apparatus capable of storing one or a plurality of recording media and managing data stored in the recording media. The library apparatus includes access control means for writing data or reading data on/from the recording medium; encrypting/decrypting means for encrypting/decrypting the data processed by the access control means; holding means for holding a processing state of the encrypting/decrypting means; and control means for determining whether the recording medium is in an encrypted state on the basis of the processing state.

### BACKGROUND OF THE INVENTION

1. Field of the Invention

The present invention relates to a technique of encrypting/decrypting data in a library apparatus capable of accommodating and managing a plurality of recording media that can be carried (hereinafter referred to as portable recording media).

2. Description of the Related Art

In recent years, leaks of data due to theft of portable recording media have frequently occurred. Accordingly, interest in a security technique to protect data has been growing. In order to prevent leaks of data due to theft of portable recording media, a method for encrypting data in the portable recording media has been used. Japanese Unexamined Patent Application Publication No. 63-224077 and Japanese Unexamined Patent Application Publication No. 4-103077 disclose techniques of checking whether encrypting/decrypting means is properly mounted in a library apparatus are disclosed in the following patent documents.

In the known arts, however, it is impossible to determine whether encrypting/decrypting means is properly set and operated and whether data in a portable recording medium is surely encrypted.

If a portable recording medium storing unencrypted data is lost, important data may leak. As a result, a user of the library apparatus may suffer from serious damage.

### SUMMARY OF THE INVENTION

The present invention is directed to enabling determination of an encryption state of a portable recording medium without special operation performed by a user of a library apparatus. Also, the present invention is directed to reliably preventing leak of data by controlling a process of ejecting a portable recording medium in an unencrypted state from the library apparatus on the basis of a detection result of the encryption state.

According to an aspect of the present invention, there is provided a library apparatus capable of accommodating one or a plurality of recording media and managing data stored in the recording media. The library apparatus includes access control means for writing data or reading data on/from the recording medium; encrypting/decrypting means for encrypting/decrypting the data processed by the access control means; holding means for holding a processing state of the encrypting/decrypting means; and control means for determining whether the recording medium is in an encrypted state on the basis of the processing state.

The library apparatus may further include notifying means for notifying of the processing state of the encrypting/decrypting means.

According to another aspect of the present invention, there is provided a library apparatus capable of accommodating one or a plurality of recording media and managing data stored in the recording media. The library apparatus includes control means for transmitting/receiving data to/from a higher-level apparatus, encrypting/decrypting data, and determining whether the recording medium is in an encrypted state on the basis of the encryption/decryption of the data; and access control means for writing data or reading data on/from the recording medium.

The library apparatus may further include display means for displaying a state of the library apparatus; and library control means for controlling the library apparatus and allowing the display means to display an encryption state on the basis of the encryption state of the recording medium notified from the control means.

According to another aspect of the present invention, there is provided a method for controlling a library apparatus capable of accommodating one or a plurality of recording media and managing data stored in the recording media. The method includes an access control step of writing data or reading data on/from the recording medium; an encrypting/decrypting step of encrypting/decrypting the data processed in the access control step; a holding step of holding a processing state in the encrypting/decrypting step; and a control step of determining whether the recording medium is in an encrypted state on the basis of the processing state.

According to the present invention, a user of the library apparatus can determine an encryption state of a portable recording medium without performing a special operation. Furthermore, a process of ejecting a portable recording medium in an unencrypted state can be suppressed, so that it can be prevented that a portable medium in an unencrypted state is carried out by mistake or that data leaks.

### BRIEF DESCRIPTION OF THE DRAWINGS

FIG. 1 shows a configuration of a library apparatus according to the present invention;

FIGS. 2A to 2C show internal configurations of drive modules;

FIG. 3 shows a format of a management table;

FIG. 4 is a flowchart showing a process of determining an encryption state of a portable recording medium according to a first embodiment;

FIG. 5 is a flowchart showing a process of determining an encryption state of a portable recording medium according to a second embodiment;

FIG. 6 is a flowchart showing a process of determining an encryption state of a portable recording medium according to a third embodiment;

FIG. 7 is a flowchart showing a process of updating the management table to manage encryption states of portable recording media and a process of determining whether a portable recording medium can be ejected when instructions to eject the medium are received;

FIGS. 8A and 8B schematically show recording on a portable recording medium; and

FIG. 9 shows an example of information stored in holding means.

### DESCRIPTION OF THE PREFERRED EMBODIMENTS

Hereinafter, embodiments of the present invention are described with reference to the drawings.

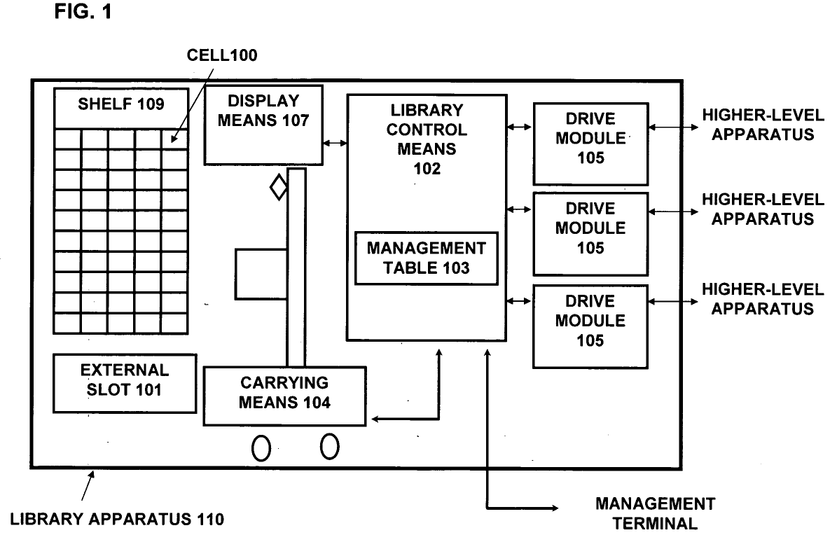

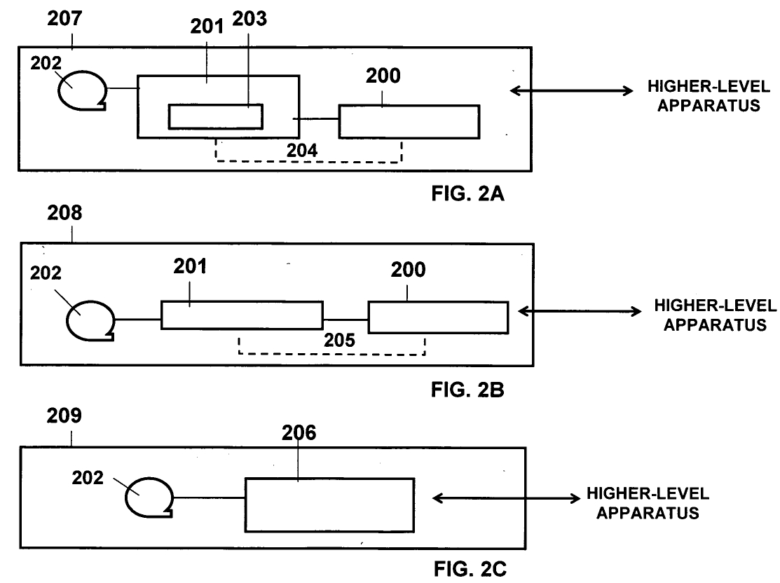

FIG. 1 shows a configuration of a library apparatus 110 according to an embodiment of the present invention. Respective portable recording media are accommodated in cells 100. Library control means 102 performs a process of supplying a portable recording medium into the library apparatus 110 and a process of ejecting a portable recording medium from the library apparatus 110 through an external slot 101. Also, the library control means 102 performs other various controls (e.g., control of a carrying device and a display device) of the library apparatus 110. A memory inside the library control means 102 stores a management table 103. The management table 103 shows existence/absence of a portable recording medium in each cell and whether data therein is encrypted. In the library apparatus 110, each portable recording medium is carried by carrying means 104 from the external slot 101 through the cell 100 to a drive module 105 on the basis of instructions from the library control means 102. The drive module 105 performs various data processes, such as transmission/reception of data to/from a higher-level apparatus, encryption/decryption of data, and access to a portable recording medium. An internal configuration of the drive module 105 is described below with reference to FIGS. 2A to 2C. Communication means 106 is used to transmit/receive control information to/from a higher-level apparatus. Display means 107 is used to display a state of the apparatus and the like.

FIGS. 2A to 2C show internal configurations of the drive module 105. FIG. 2A shows an internal configuration of a drive module 207 according to a first embodiment described below. Control means 200 shown in FIG. 2A transmits/receives data to/from a higher-level apparatus. Encrypting/decrypting means 201 encrypts/decrypts data processed by the control means 200. Holding means 203 records a result of an encrypting/decrypting process. The holding means 203 may have a configuration of holding a log file or the like in a nonvolatile memory or a configuration of setting a value according to a process in a register or the like. Access means 202 performs accessing processes, such as write/read of data on/from a portable recording medium. Obtaining means 204 may connect the encrypting/decrypting means 201 and the control means 200 by using an interface, such as a LAN or serial connection, or may connect them in a hardware manner, by using a signal line dedicated to obtain encryption/decryption processing information.

FIG. 2B shows an internal configuration of a drive module 208 according to a second embodiment described below. The encrypting/decrypting means 201 does not have the holding means 203 to hold a result of an encrypting/decrypting process. The drive module 208 includes notifying means 205 for transmitting a result of an encrypting/decrypting process performed on data from the encrypting/decrypting means 201 to the control means 200. The notifying means 205 used here may have a configuration of connecting the control means 200 and the encrypting/decrypting means 201 by a signal line in a hardware manner, or a configuration using a method used in typical circuit design. The other points are the same as those in the drive module 207 shown in FIG. 2A.

FIG. 2C shows an internal configuration of a drive module 209 according to a third embodiment described below. In this configuration, control means 206 performs an encrypting/decrypting process. For example, encryption/decryption is performed by using firmware operated in the control means 206. The other points are the same as those in the drive module 207 shown in FIG. 2A.

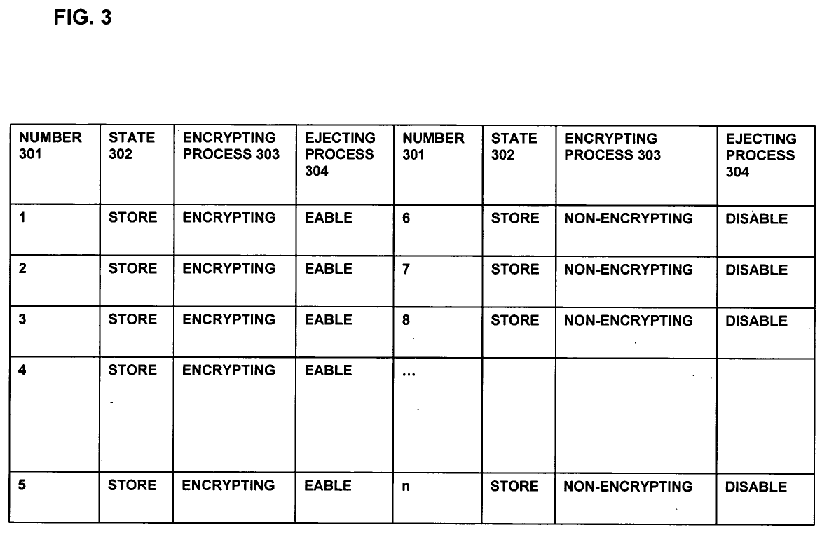

FIG. 3 shows a format of the management table 103. A first column 301 shows cell numbers of cells accommodating portable recording media. A second column 302 shows whether the respective cells accommodate portable recording media. A third column 303 shows whether an encrypting process has been done on the portable recording medium accommodated in each cell. A fourth column 304 shows whether an ejecting process is permitted to the portable recoding medium accommodated in each cell. The setting of the fourth column 304 can be changed from a management terminal connected via a network 108.

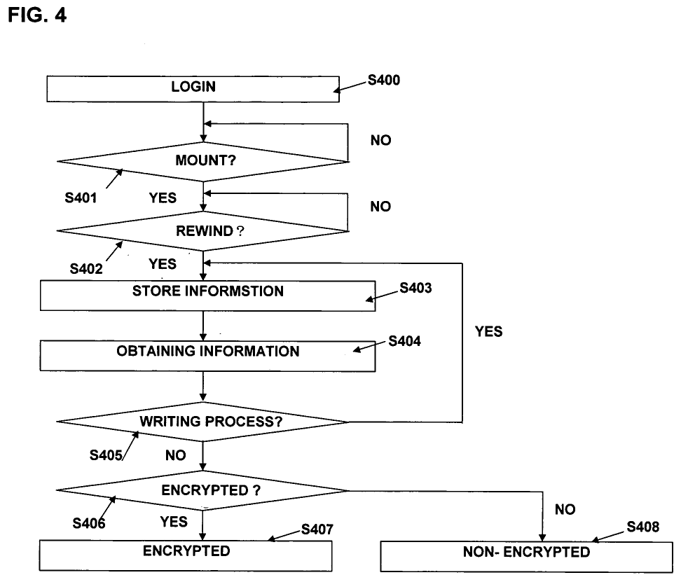

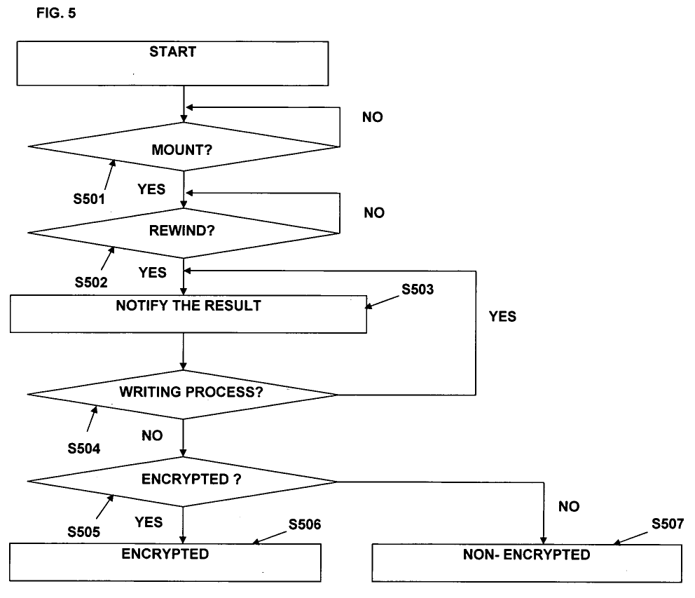

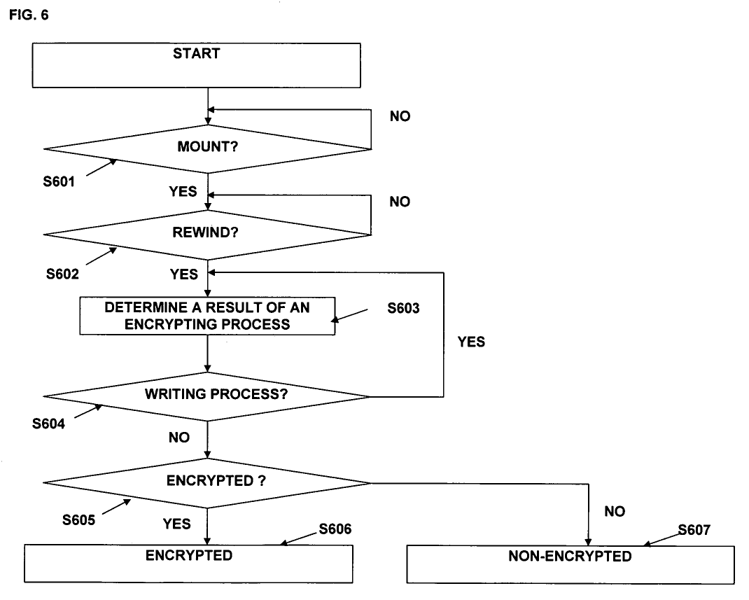

FIGS. 4 to 6 are flowcharts showing methods for detecting an encryption state of a portable recording medium. FIG. 4 is a flowchart corresponding to a case where the drive module shown in FIG. 2A is used, FIG. 5 is a flowchart corresponding to a case where the drive module shown in FIG. 2B is used, and FIG. 6 is a flowchart corresponding to a case where the drive module shown in FIG. 2C is used.

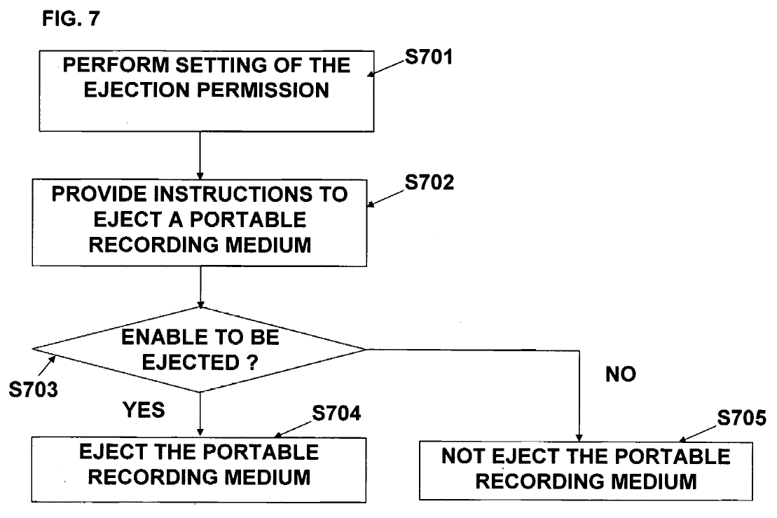

FIG. 7 is a flowchart showing a process of updating the management table 103 to manage encryption states of portable recording media and a process of determining whether a portable recording medium can be ejected when instructions to eject the portable recording medium are received.

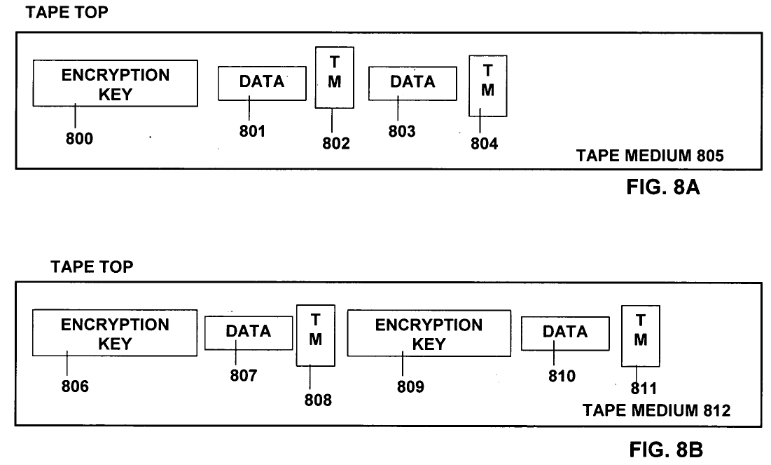

FIGS. 8A and 8B are schematic views showing encryption keys 800, 806, and 809 and data 801, 803, 807, and 810 recorded in tape media 805 and 812, respectively.

FIG. 8A is a schematic view showing a case where the data 801 and 803 in the tape medium 805 are encrypted/decrypted by using the encryption key 800. The encryption key 800 is held in a head area of the tape medium 805. The encrypting/decrypting means 201 encrypts/decrypts the data 801 and 803 in the portable recording medium by using the encryption key 800 held in the head area. Herein, TMs 802 and 804 in FIG. 8A represent tape marks. The tape mark is attached to data of each file and plays a role of a separating point between files.

FIG. 8B is a schematic view showing a case where the data 807 and 810 are encrypted/decrypted by using the encryption keys 806 and 809, respectively. The encrypting/decrypting means 201 can recognize the data 807 and 810 recorded on the tape medium 812 in units of files by detecting tape marks 808 and 811 serving as separating points between files. In a process of writing data in the tape medium 812, the encrypting/decrypting means 201 first records the encryption key 806 at the head of the tape medium 812. Then, after recording the data 807 and the tape mark 808, the encrypting/decrypting means 201 records the encryption key 809. In this way, by recording the encryption keys 806 and 809 on the tape medium 812, the data 807 and 810 can be encrypted/decrypted in units of files. Likewise, in a reading process, the encrypting/decrypting means 201 may decrypt the data 810 by using the encryption key 806 at the head of the tape medium 812 and the encryption key 809 recorded after the tape mark 808.

Now, the first embodiment according to the present invention is described with reference to the flowchart shown in FIG. 4.

After the power of the library apparatus has been turned on, the control means 200 establishes the obtaining means 204 to obtain information held in the holding means 203 in the encrypting/decrypting means 201 (S400). For example, the obtaining means 204 has a configuration of connecting the encrypting/decrypting means 201 to the control means 200 by using an interface, such as a LAN or serial connection. When the control means 200 wants to obtain encryption/decryption information held in the holding means 203, the control means 200 performs a login process to the encrypting/decrypting means 201 by using the above-described interface so as to establish the obtaining means 204. On the other hand, in a case where the obtaining means 204 is realized by connecting the encrypting/decrypting means 201 to the control means 200 by using a signal line dedicated for obtaining encryption/decryption information in a hardware manner, the encryption/decryption information held in the holding means 203 is obtained.

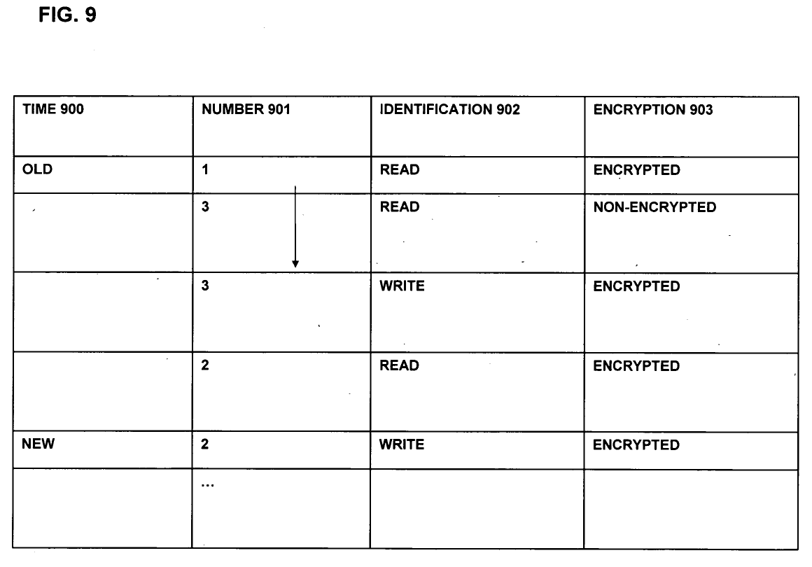

The control means 200 determines whether a portable recording medium has been mounted on the drive module 105 (S401). When determining that a portable recording medium has been mounted on the drive module 105, the control means 200 determines whether a rewind process should be performed on the portable recording medium (S402). The rewind process is a process to access the head of the portable recording medium. After the rewind process has been executed and completed, the encrypting/decrypting means 201 provides instructions to read head data, and the access means 202 reads the specified data from the portable recording medium. In this reading process, if the encryption key 800 attached to the data 801 is detected, that means the encrypted data 801 is stored in the portable recording medium. In that case, the encrypting/decrypting means 201 determines that the data in the portable recording medium has been encrypted, stores information indicating that the portable recording medium is in an encrypted state in the holding means 203. If the access means 202 does not detect the encryption key 800, the encrypting/decrypting means 201 stores information indicating that the portable recording medium is in an unencrypted state in the holding means 203 (S403). In a specific storing method, for example, it is desirable to store series of data, such as cell numbers indicating portable recording media, types of process, and information indicating whether data is encrypted, in time series, as shown in FIG. 9. After the process of checking the encryption key 801, the control means 200 performs a rewind process again on the portable recording medium in order to access the head of the portable recording medium.

Then, the control means 200 performs a process of obtaining information about a processing result held in the holding means 203 in order to obtain an encryption state of the portable recording medium checked by the encrypting/decrypting means 201 (S404). In this case, if a login process (S400) is performed to the encrypting/decrypting means, the information can be obtained by performing a process of capturing a log file. This is realized by performing a process equivalent to a process of obtaining a log file from a typical management terminal from the control means 200.

On the other hand, if the encrypting/decrypting means 201 and the control means 200 are connected to each other in a hardware manner and if a register or the like is used as the holding means 203, an encryption state of the portable recording medium can be easily obtained by referring to the register, without performing a login process.

Any type of information can be used as the information held in the holding means 203 as long as whether encryption has been done can be determined. For example, an unencrypted state may be represented by “0”, and an encrypted state may be represented by “1”.

Then, when a higher-level apparatus accesses the drive module 105, the control means 200 analyzes the type of the access and provides instructions to perform a reading/writing process to the access means 202. If a writing process is requested by the higher-level apparatus, the encrypting/decrypting means 201 encrypts the data 801, adds the encryption key 800 to the head of the data 801, and records information indicating that the data 801 is encrypted in the holding means 203. Then, the access means 202 writes the encrypted data 801 on the portable recording medium.

The control means 200 determines whether the access means 202 has performed a writing process (S405). If the access means 202 has performed a writing process, there is a possibility that a change occurs in the encryption state of the portable recording medium (e.g., a process of writing encrypted data on an unused portable recording medium), so that the control means 200 obtains held information again. On the other hand, if the access means 202 has performed a reading process, the access means 202 reads the data 801, and the encrypting/decrypting means 201 determines whether the encryption key 800 is attached to the read data 801. If the encryption key 800 is attached to the data 801, the encrypting/decrypting means 201 decrypts the data 801. After the data 801 has been decrypted, the control means 200 transfers the data 801 to the higher-level apparatus. At this time, no change occurs in the encryption state of the portable recording medium, so that there is no need to check the encryption state again.

Then, when determining that the access means 202 has performed a reading process, the control means 200 analyzes the held information obtained from the holding means 203, so as to determine whether the data 801 has been encrypted (S406, S407, and S408).

When an encrypting/decrypting process is performed on the data 807 and 810 in units of files, the encrypting/decrypting means 201 needs to check the encryption keys 806 and 809 in units of files. Thus, the encrypting/decrypting means 201 needs to perform a process of checking the encryption keys 806 and 809, performed after a rewind process on the portable recording medium, also after the tape marks 808 and 811 have been detected.

That is, in a process of reading the data 810, it is determined whether the data 810 and the encryption key 809 can be read, and the determination result is recorded in the holding means 203. Then, a rewind process is performed so that the data 810 can be read, and a reading position is set to the head of the data 810.

On the other hand, in a writing process, a process of encrypting the data 807 and 810 and adding the encryption keys 806 and 809 is performed, and the processing state is recorded in the holding means 203.

Thus, the control means 200 checks the encryption state recorded in the holding means 203 after the tape marks 808 and 811 have been detected and at a writing process thereafter, in addition to at mounting and at writing of data in the head area.

According to this embodiment, even if the encrypting/decrypting means 201 is provided in the interface and if an encrypting/decrypting process on data is automatically performed, whether the encrypting/decrypting process has properly been performed can be determined.

Next, the second embodiment according to the present invention is described. FIG. 5 is a flowchart according to the second embodiment. In the second embodiment, the drive module 105 includes the notifying means 205 for transmitting a result of an encrypting/decrypting process performed on data from the encrypting/decrypting means 201 to the control means 200. The notifying means 205 is realized by connecting the control means 200 to the encrypting/decrypting means 201 by a signal line dedicated for notification. The control means 200 determines whether a portable recording medium has been mounted on the drive module 105 (S501). When determining that a portable recording medium has been mounted on the drive module 105, the control means 200 determines whether a rewind process should be performed on the portable recording medium (S502). The rewind process is a process of accessing the head of the portable recording medium. After the rewind process has been executed and completed, the encrypting/decrypting means 201 provides instructions to read head data, so that the access means 202 reads specified data from the portable recording medium. Then, the notifying means 205 notifies the control means 200 of a result of the encrypting process of the portable recording medium detected in the reading process (S503). Then, the control means 200 determines whether the access means 202 has performed a writing process (S504). If the access means 202 has performed the writing process, the notifying means 205 notifies the control means 200 of a result of the encrypting process again. On the other hand, if the access means 202 has performed a reading process, the access means 202 reads the data 801, and the encrypting/decrypting means 201 determines whether the encryption key 800 is added to the read data 801. Then, the control means 200 determines whether the data 801 has been encrypted on the basis of the result of the encrypting process notified from the notifying means 205 (S505, S506, and S507). According to the second embodiment, the encryption state of the data 801 is transmitted from the encrypting/decrypting means 201 to the control means 200 as necessary, so that the control means 200 need not request for obtaining the encryption state. Accordingly, the circuit design or the firmware design of the control means 200 can be simplified.

Next, the third embodiment according to the present invention is described. FIG. 6 is a flowchart according to the third embodiment. In the third embodiment, an encrypting/decrypting process is performed by firmware in the control means 206. Alternatively, an encrypting/decrypting circuit is added to the control means 206, and the process performed by the encrypting/decrypting means in the first and second embodiments is performed by the control means 206. The control means 206 determines whether a portable recording medium has been mounted on the drive module 105 (S601). When determining that a portable recording medium has been mounted on the drive module 105, the control means 206 determines whether a rewind process should be performed on the portable recording medium (S602). After the rewind process has been executed and completed, the control means 206 determines a result of an encrypting process on the portable recording medium (S603). Then, the control means 206 determines whether the access means 202 has performed a writing process (S604). If the access means 202 has performed a writing process, the control means 206 determines the result of the encrypting process again. On the other hand, if the access means 202 has performed a reading process, the access means 202 reads the data 801, and the encrypting/decrypting means 201 determines whether the encryption key 800 is added to the read data 801. Then, the control means 200 determines whether the data 801 has been encrypted (S605, S606, and S607).

Furthermore, in the third embodiment, the drive module 105 requires neither the holding means 203 nor the notifying means 205. Thus, the circuit and firmware required for a checking process or a notifying process of the holding means 203 can be omitted. Accordingly, the design of the drive module 105 can be significantly simplified.

Also, in any of the first, second, and third embodiments, the library apparatus 110 can display an encryption state of a portable recording medium that is mounted on the drive module 105 and that is accessed from a higher-level apparatus by using the library control means 102 and the display means 107.

The information notified here is identification information of the drive module 105 and an encryption state of a portable recording medium. Typically, a plurality of drive modules 105 are mounted on one library apparatus 110. Thus, identification information of each drive module 105 is to be notified. However, if identification can be performed without notification to the library apparatus 110, e.g., if only one drive module 105 is mounted, notification is unnecessary. The notifying means from the control means 200 used here may be typical communication means, such as a LAN. Also, a method of connecting the drive module and the library control means in a hardware manner may be used.

Upon receiving notification from the control means 200, the library control means 102 may notify the higher-level apparatus of an encryption state by using the communication means 106 to the higher-level apparatus. Accordingly, the higher-level apparatus can display information about the encryption state on a console mounted thereon.

The communication means 106 includes a typical data transmitting interface, such as a LAN, serial, or a fiber channel. Hereinafter, a method for managing an encryption state of a portable recording medium and an operation performed when instructions to eject the portable recording medium are received are described.

FIG. 7 is a flowchart showing a process of determining whether a portable recording medium can be ejected. The library control means 102 performs setting of the ejection permission column 304 of the management table 103 on the basis of instructions from a management terminal connected via the network (S701). The setting may be made in advance: an encrypted portable recording medium can be ejected and an unencrypted portable recording medium cannot be ejected. It may be possible that even a portable recording medium in an unencrypted state needs to be ejected from the library apparatus, for example, at emergency. Therefore, it is desirable that the setting can be changed so that a portable recording medium in an unencrypted state can be ejected at emergency. Accordingly, a user of the library apparatus 110 can flexibly take action on the basis of a system operation policy or the like. For example, in a portable recording medium that should be strictly managed, setting is made so that the portable recording medium cannot be ejected even if it is in an encrypted state. Furthermore, the setting needs to be changed by an administrator when the medium is to be ejected. Accordingly, the security can be enhanced. The setting of ejection permission may be made in units of cells as in this embodiment, or may be made for all of the cells in the library apparatus 110.

Upon receiving input from a user of the library apparatus 110 or an operator, the library control means 102 provides instructions to eject a portable recording medium (S702). The library control means 102 recognizes the cell number of the cell accommodating the portable recording medium to be ejected, refers to the encryption state column 303 of the target cell number in the cell number column 300 in the management table 103, and determines whether the portable recording medium to be ejected can be ejected (S703).

If it is determined in S703 that the portable recording medium is in an encrypted state and can be ejected, the library control means 102 allows the carrying means 104 to carry the portable recording medium to the external slot 101, so that the portable recording medium is ejected from the library apparatus 110 (S704). If whether the medium can be ejected or not is to be determined even in an encrypted state, the library control means 102 may check the ejection permission column 304. If it is determined in step S703 that the portable recording medium is in an unencrypted state and cannot be ejected, the library control means 102 does not eject the portable recording medium (S705).

After the portable recording medium has been ejected, the library control means 102 initializes each item of the target cell number in the management table 103. For example, the accommodation state column 302 is set to “unaccommodated”, and the encryption state column 303 is set to “unencrypted”.

If the portable recording medium is in an unencrypted state, the library control means 102 further checks the ejection permission column 304. If the setting permits ejection of the portable recording medium in an unencrypted state, the same process as the process of ejecting a portable recording medium in an encrypted state may be performed. On the other hand, if the setting does not permit ejection, the ejecting process is stopped.

If it is determined that the portable recording medium cannot be ejected, the library control means 102 may allow the display means 107 of the library apparatus 110 to display a caution saying that the medium cannot be ejected. Alternatively, the library control means 102 may notify the higher-level apparatus that the medium cannot be ejected so that the message is displayed on a console or the like mounted on the higher-level apparatus. The described embodiment processes are implemented in software and/or computing hardware. The present invention is not limited to the above-described embodiments, but various modifications can be applied without deviating from the scope of the present invention.

What is claimed is:

1. An apparatus capable of storing a plurality of recording media and managing data stored in the recording media, the apparatus comprising:
an access controller for selecting a recording medium from the plurality of recording media, and for writing data or reading data on/from the selected recording medium;
an encrypting/decrypting unit for encrypting the data to be stored in the recording medium and decrypting the data read out from the recording medium;
a storing unit for storing an encryption status of the data in the recording medium; and
a controller for determining whether to allow removal of a recording medium from the apparatus according to the encryption status of said recording medium.

2. The apparatus according to claim 1, further comprising:
notifying unit for notifying of the processing result of encrypting/decrypting data in the recording medium.

3. The apparatus according to claim 1, further comprising:
display unit for displaying encryption status of the data in the recording medium; and
library controller for controlling the apparatus and allowing the display unit to display the encryption status of said recording medium in reference to said storing unit.

4. The apparatus according to claim 1, further comprising:
communicating unit for communicating with a higher-level apparatus; and
library controller for controlling the apparatus and notifying the higher-level apparatus the encryption status of the recording medium.

5. A apparatus capable of housing a plurality of recording media and managing data stored in the recording media, the apparatus comprising:
ejector for ejecting a recording media from the apparatus;
an encryption management table indicative of a relation between the recording media and encryption status of the recording media and
library controller for controlling the ejector and determining whether to allow removal of a recording medium from the apparatus in reference to the encryption management table upon receiving instructions to eject the recording medium.

6. The apparatus according to claim 5, wherein, upon receiving instructions to eject the unencrypted recording medium, the library controller allows the display unit to display a message indicative of disabling to eject the recording medium from the apparatus.

7. The apparatus according to claim 5, further comprising:
communicating unit for communicating with a higher-level apparatus,
wherein, upon receiving instructions to eject the unencrypted recording medium, the library controller notifies the higher-level apparatus to enable to eject the recording medium.

8. The apparatus according to claim 5, wherein the encryption management table includes information about whether to enable to eject a unencrypted recording medium or not, the information being set from a management terminal via a network, and
wherein, upon receiving instructions to eject an unencrypted portable recording medium, the library controller refers to the information about whether to enable to eject the portable recording medium in the encryption management table and determines whether to enable to eject the unencrypted the recording medium.

9. A method for controlling a apparatus capable of storing a plurality of recording media and managing data stored in the recording media, the method comprising the steps of:
selecting a recording medium from the plurality of recording media, and for writing data or reading data on/from the selected recording medium;
encrypting the data to be stored in the recording medium and decrypting the data read out from the recording medium;
storing an encryption status of the data in the recording medium; and
determining whether to allow removal of a recording medium from the apparatus according to the encryption status of said recording medium.
